(19) United States
(12) Patent Application Publication
(10) Pub. No.: US 2024/0362601 A1
(43) Pub. Date: Oct. 31, 2024

(54) METHOD, ELECTRONIC DEVICE AND SYSTEM FOR MANAGING ONLINE DIGITAL ASSETS

(71) Applicant: Bandberry Limited, Hong Kong (HK)

(72) Inventors: Alex LAU, Hong Kong (HK); Pui Tong Paul LEE, Hong Kong (HK)

(21) Appl. No.: 18/687,818

(22) PCT Filed: Aug. 29, 2022
(86) PCT No.: PCT/CN2022/115463

§ 371 Date: Feb. 29, 2024

Related U.S. Application Data
(60) Provisional application No. 63/238,212, filed on Aug. 29, 2021.

(51) Int. Cl. G06Q 20/12

(52) U.S. Cl. CPC G06Q 20/1235

(57) ABSTRACT

A method for managing online digital assets is provided. The method includes: receiving a first input data generated in response to an applied first input operation; enabling a target module among a plurality of modules according to the first input data, wherein the modules comprise a home page module, a creation module, a collaboration module, a marketplace module, a consumer module and a curation module; receiving a second input data generated in response to an applied second input operation; performing a target operation of the target module for managing the online digital asset according to the second input data; sending a first request corresponding to the target operation to a server; and receiving a first response corresponding to the first request from a server, wherein the first response is generated via a smart contract corresponding to the target operation, so as to complete the management of the online digital asset.

### CROSS-REFERENCE TO OTHER APPLICATIONS

The present application claims priority to U.S. Provisional Patent Application No. 63/238,212 filed Aug. 29, 2021; the disclosure of which is incorporated herein by reference in its entirety.

### FIELD OF THE INVENTION

The present invention generally relates to online digital asset marketplaces for trading intangible digital assets.

### BACKGROUND OF THE INVENTION

Recent trends in technology have made digital assets more and more important. For example, music, paintings, pictures, photos, films and so on can be used, enjoyed, saved, transferred and traded in digital form. Blockchain systems and the development of Non-Fungible Token (NFT) technology also allow digital assets to be transferred from one user to another with trust and security.

However, despite attempts to develop one, currently there is no complete platform or market for integrating the widely varied functions necessary for users to manage digital assets. Such a system would serve a major unmet need.

### SUMMARY OF THE INVENTION

In accordance to one aspect of the present invention, a computer-implemented method for managing an online digital asset by an electronic device of a system is provided. The method comprises: receiving, by a first processor of the electronic device, a first input data generated in response to a first input operation, wherein the first input operation is implemented by an I/O circuit of the electronic device; enabling, by the first processor, a target module among a plurality of modules according to the first input data, wherein the modules comprise a home page module, a creation module, a collaboration module, a marketplace module, a consumer module, a curation module, and a verifier module; receiving, by the first processor, a second input data generated in response to a second input operation; executing, by the first processor, a target operation of the target module according to the second input data; sending, by the first processor, a first request corresponding to the target operation to a server; receiving, by the first processor, a first response corresponding to the first request from a server, wherein the first response is generated by a second processor of the server via a smart contract corresponding to the target operation.

In accordance with another aspect of the present invention, an electronic device for managing an online digital asset is provided, and the electronic device includes one or more processors configured to execute machine instructions to implement the method described above.

In accordance with another aspect of the present invention, a system for managing an online digital asset is provided, and an electronic device of the system includes one or more processors configured to execute machine instructions to implement the method described above.

### BRIEF DESCRIPTION OF THE DRAWINGS

Embodiments of the invention are described in more details hereinafter with reference to the drawings, in which:

FIG. 1A depicts a block diagram illustrating an electronic device of a system for managing online digital asset in accordance with one embodiment of the present invention;

FIG. 1B depicts a block diagram illustrating the program modules stored in a non-transient memory circuit of the electronic device;

FIG. 1C depicts a block diagram further illustrating the program modules stored in the non-transient memory circuit of the electronic device;

FIG. 2 depicts a schematic diagram illustrating the operations performed by the system;

FIG. 3 depicts another schematic diagram further illustrating the operations performed by the system;

FIG. 4 depicts a flowchart of managing online digital asset in accordance with one embodiment of the present invention;

FIG. 5 depicts a Home page user interface (UI) generated by a home page module in accordance with one embodiment of the present invention;

FIG. 6 depicts an Explore UI generated by a explore module in accordance with one embodiment of the present invention;

FIG. 7 depicts a Play List UI generated by a curation module in accordance with one embodiment of the present invention;

FIG. 8A-8D depict the Marketplace UIs generated by a provided marketplace module in accordance with one embodiment of the present invention;

FIG. 9 depicts a Track Notes UI generated by a provided track module in accordance with one embodiment of the present invention;

FIG. 10A-10B depict the Profile UIs generated by a provided profile module in accordance with one embodiment of the present invention;

FIG. 11A-11B depicts the Project UIs generated by a provided Project module in accordance with one embodiment of the present invention; and

FIG. 12 depicts a Discover UI, a further Marketplace UI and a further Profile UI displayed and controlled by the electronic device in accordance with one embodiment of the present invention.

### DETAILED DESCRIPTION

In the following description, methods, electronic devices, and systems for managing online digital asset and the likes are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

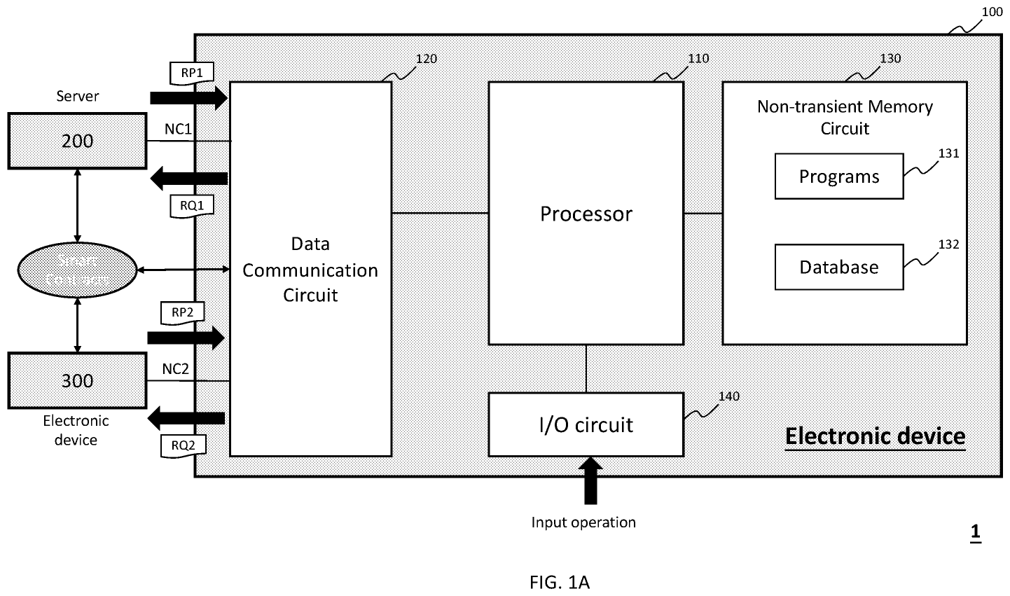

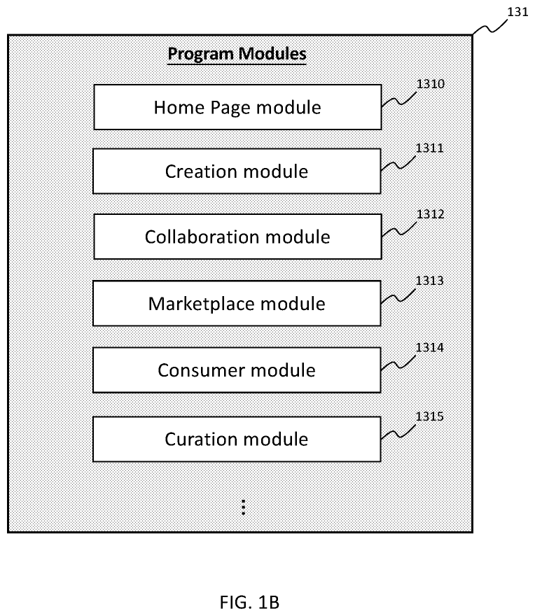

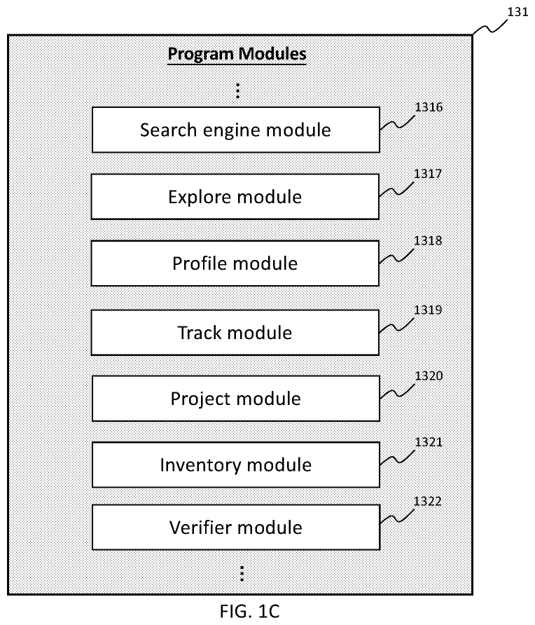

Referring to FIG. 1A for the following description. In accordance with various embodiments of the present invention, system 1 includes an electronic device 100 and a server 200. The electronic device 100 includes a first processor 110, a data communication circuit 120, a non-transient memory circuit 130, and an I/O circuit 140. In one embodiment, the electronic device may be, without limitation, a tablet computer, a mobile electronic device, AR/VR HUD, a smartphone, a PC, or a laptop computer. The server 200 includes a second processor, configured to manage overall operations of the server 200.

The data communication circuit 120 is configured to establish a network connection (e.g., NC1 or NC2) with server 200 and/or another electronic device 300. The electronic device 100 can send request RQ1 to the server 200 or RQ2 to the electronic device 300, such that the server 200 can feedback/generate a response RP1 according to the received request RQ1, or the electronic device 300 can feedback/generate a response RP2 according to the received request RQ2. The response RP1 and the response RP2 will be sent back to the electronic device 200 via the established network connections NC1 and NC2.

Furthermore, the electronic device 100, the server 200, and the electronic device 300 are configured to connect to the Internet for transaction executions and/or data exchanges with smart contracts hosted by other electronic devices.

The non-transient memory circuit 130 is configured to store the program or machine instruction modules 131 and to host the database 132. The database 132 may be used to store various blockchain smart contracts, blocks of one or more blockchains, and information related to the managed digital assets.

Referring to FIG. 1B, the program or machine instruction modules 131 include: a Home page module 1310; a Creation module 1311; a Collaboration module 1312; a Marketplace module 1313; a Consumer module 1314 and a Curation module 1315.

Furthermore, in another embodiment, referring to FIG. 1C, the program or machine instruction modules 131 further include: a Search engine module 1316; an Explore module 1317; a Profile module 1318; a Track module 1319; a Project module 1320; an Inventory module 1321; and a Verifier module 1322.

The I/O circuit 140 is electrically (wired or wirelessly) connected to, for example, a touch display screen or other display and suitable user interface devices for image/video display and user input receiving. In one embodiment, the I/O circuit 150 generates input data/signals according to an input operation implemented by the touch display screen or other suitable display and user input devices, and the generated input data is sent to the first processor 110. In another embodiment, the first processor 110 instructs the I/O circuit 140 to display or playback media contents in the UI related to the managed digital assets.

The first processor 110 executes the program or machine instruction modules 131 to implement methods in accordance with various embodiments of the present invention. The aforementioned program or machine instruction modules are executed by the first processor 110 and/or the second processor.

In accordance with various embodiments, the arrangement of the one or more electronic devices 100 and 300, and the server 200, with the corresponding data communication network, implementing and executing the program or machine instruction modules 131 forms an online digital asset marketplace. The online digital asset marketplace facilitates the creations of digital assets; trading, including buy, sell, and resell, of digital assets; listing and promotion of digital assets within the online digital asset marketplace as well as external systems such as the various social media platforms; and investing and divesting in ownerships in digital assets.

To simplify the illustration of the embodiments of the present invention, throughout this document, participants of the online digital asset marketplace are labeled with the logical roles: Creator, Consumer, Curator, Investor, Collaborator, and Verifier according to the actions and purposes carried out by the different types of participants. For example, a Creator is one who creates a digital asset or generates a digital version of a physical asset, and the Creator may be regarded as the original owner of that digital asset. A Consumer is the one who pays a usage fee for a digital asset. A Curator is one who creates and manages one or more arrangements and/or collections of digital assets aim to be followed by other follower participants. By her followings, the Curator exerts influences on the digital assets included in her arrangements and/or collections; as such the Curator may be rewarded a portion of the usage fee or license fee earnings on the included digital assets. An Investor is one who buys and holds one or more shares in a digital asset or invests in a project of creating a digital asset; and as such the Investor has rights to claim a portion of earnings made from her invested digital asset. A Collaborator is one who collaborates with other participants in promoting a digital asset, or contributing non-monetary value in a project of creating a digital asset; as such the Collaborator may be rewarded a portion of the usage fee or license fee earnings on the included digital assets. A Verifier is one who verify or endorse a Creator or a digital asset; and should be someone generally trusted and/or well respected by Consumers, such as a domain key opinion leader (KOL) or a celebrity. A Verifier may be nominated by the user community of the online digital asset marketplace. When a Verifier announces her verification on or endorsement of a Creator or a particular digital asset, such announcement generates a positive influence on the Creator or digital asset; as such the Verifier may be rewarded a portion of the of the usage fee or license fee earnings on the verified or endorsed digital assets of the Creator or the particular digital asset.

The digital assets may include, without limitation, music, sound (audio), motion pictures (videos), podcasts, visual arts, literatures, and/or compilation of media contents of various types. Each digital asset is tokenized based on NFT technology so to allow the various online transactions on the digital asset based on the Blockchain technology. The transactions, such as changes in ownership, licensing and usage fee incurrences and payments, on the digital assets are recorded in blocks added to a distributed ledger of a marketplace Blockchain of the online digital asset marketplace. Copies of the ledger of the marketplace Blockchain are maintained by the electronic devices 100 and 300, and the server 200, functioning as nodes of the Blockchain ecosystem. With the marketplace Blockchain, naturally cryptocurrency is the financial instrument of choice for conducting the transactions on the digital assets. However, fiat currency as the financial instrument is also readily adoptable by the online digital asset marketplace. Lastly, one or more smart contracts are employed with the marketplace Blockchain encapsulating one or more of the program or machine instruction modules 131 for their remote executions in carrying out the transactions on the digital assets.

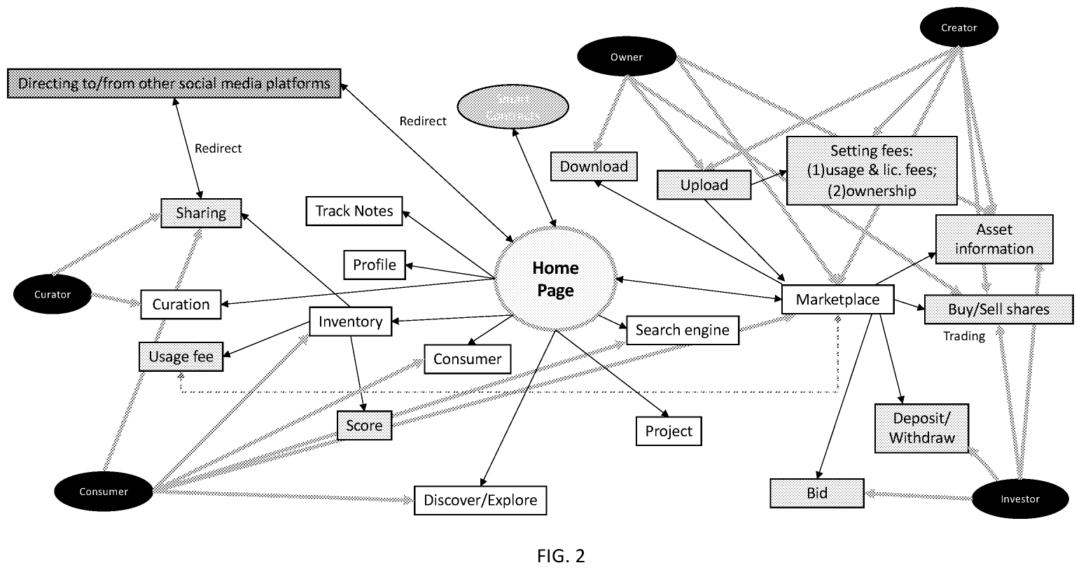

Referring to FIG. 2, the first processor 110 executes programs or machine instructions to drive the displaying of corresponding primary UIs, such as Home page UI, Search engine UI, Marketplace UI, Project UI, Discover/Explore UI, Consumer UI, Inventory UI, Profile UI, Curation UI, Verification UI, and Track Notes UI.

Some of the primary Uis may have one or more sub-Uis. For example, the Marketplace UI may have an Upload sub-UI, a Download sub-UI, an Asset information sub-UI, a Buy/Sell shares sub-UI, a Deposit/Withdraw sub-UI, and a Bid sub-UI; the Inventory UI may have a Score sub-UI, a Usage fee sub-UI and a Sharing sub-UI.

For example, the Owner/Creator may upload her digital asset to the marketplace via the Upload sub-UI, or download her digital asset from the marketplace via the Download sub-UI. In one embodiment, after the digital asset is uploaded, the Owner/Creator may set related fees, such as a usage fee and license fee, wherein the usage fee indicates a cost a Consumer should pay for each instance of usage/playback of that uploaded digital asset, and the license fee indicates a one-time cost a Consumer should pay for having a copy of that uploaded digital asset. In one embodiment, the uploaded digital asset is stored in the server 200 with linking data stored as a block added to the ledger of the marketplace Blockchain. In another embodiment, the uploaded digital asset file itself is stored as a block added to the ledger of the marketplace Blockchain. The corresponding usage fee and license fee may also be stored as one or more blocks added to the ledger of the marketplace Blockchain.

The Consumer may score a digital asset in her inventory via the Score sub-UI in the Inventory UI, or pay the usage fee for usage/playback of the digital asset via the Usage fee sub-UI. In a further embodiment, Usage fee sub-UI is omitted, and the usage fee can be charged automatically if the Consumer agrees to pay this fee when starting to use or playback the digital asset as a trigger to a smart contract managed/interacted by Marketplace module to execute a usage fee charging transaction. The charged usage fee charging transaction is added as a block to the ledger of the marketplace Blockchain, and the total revenue from all usages of the digital asset can be calculated.

The Consumer and the Curator can share link of the digital asset or their arrangements and collections (i.e. playlists) to other social media platforms via the Sharing sub-UI, or share the link to a piece of digital content from social media platforms to their Playlist UI (not shown) or Inventory UI.

The Investor may bid on a digital asset via the Bid sub-UI, or trade shares of a digital asset via the Buy/Sell shares sub-UI.

The Owner, Creator, and Investor can review the information of a specific digital asset via the Asset information sub-UI. Furthermore, the Creator and the Owner may be permitted access to further edit that information via the Asset information sub-UI.

A participant to the online digital marketplace may deposit or withdraw money in fiat currency or cryptocurrency used in the online digital asset marketplace via the Deposit/Withdraw sub-UI. The account of each participant is recorded as blocks added to the ledger of the marketplace Blockchain.

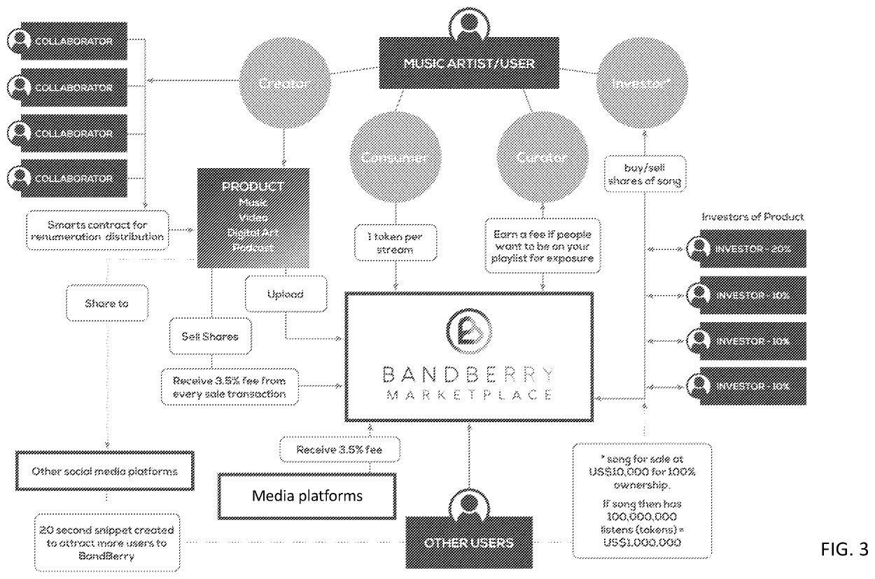

Referring to FIG. 3, for example, a music artist/consumer may have four types of identities: Creator, Consumer, Curator and Investor. The Creator generates PRODUCT (digital assets). The PRODUCT can be uploaded to the online digital asset marketplace. When selling usages or licenses of PRODUCT, the online digital asset marketplace may receive X % commission fee from each sale (usage and license) transaction, in which the value of X can be customized. The PRODUCT can be further shared to other social media platforms, and a snippet of M seconds length, in which the value of M can be customized. The snippet is created to attract other Consumers and external users to the marketplace. The online digital asset marketplace may receive Y % commission fee from an external social media platform or vice versa under certain fee sharing arrangement. There may be Collaborators who help to prompt or distribute the PRODUCT. The Consumer pays a usage fee (e.g., 1 token or US $0.01) per stream of the PRODUCT to the marketplace. The Curator may earn a fee for including the PRODUCT in her playlist for exposure for the benefit (promotion of the digital asset) of the Creator. A renumeration smart contract is configured for the automatic distribution of such renumerations from the difference sources to the different participants and systems, and recording the renumeration distribution as blocks added to the ledger of the marketplace Blockchain.

A Creator may sell shares in the PRODUCT to an Investor, and the Investor may buy or resell shares in the PRODUCT in the online digital asset marketplace. Revenues generated by the PRODUCT are then distributed to the Creator and/or Investor(s) according to their shareholding percentages in the PRODUCT. For example, if a song is for sale at US $10,000 for 100% ownership, the cost for buying 10% shares is US $1,000. If this song is streamed 100,000,000 times, the gross revenue is US $1,000,000; after subtracting the various commission fees to arrive at a net revenue; and portions of this net revenue are distributed as dividends to all of its Investors according to their shareholding percentages. A dividend smart contract is provided, or the renumeration smart contract is further configured, for the automatic distribution of such dividends to the difference sources to the different participants and recording the dividend distribution as blocks added to the ledger of the marketplace Blockchain.

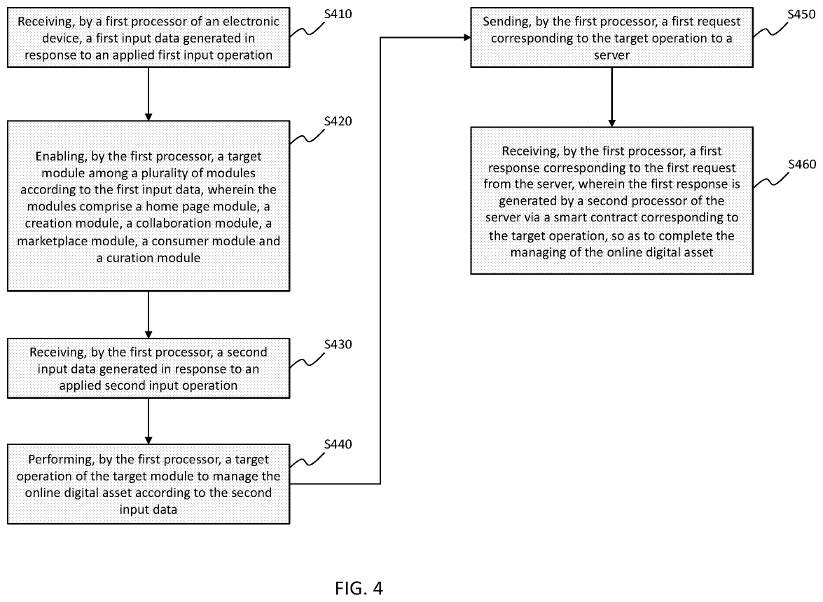

Referring to FIG. 4, in step S410, the processor 110 receives a first input data generated in response to an applied first input operation.

Next, in step S420, the processor 110 initiates a target module among a plurality of modules according to the first input data, wherein the modules comprise a Home page module, a Creation module, a Collaboration module, a Marketplace module, a Consumer module, a Curation module, and a Verifier module. For example, the first input is for initiating the target module (e.g., a click on an UI icon corresponding to the target module, so as to execute the target module).

Next, in step S430, the processor 110 receives a second input data generated in response to an applied second input operation.

Next, in step S440, the processor 110 executes a target operation of the target module to manage the digital asset according to the second input data. For example, the second input operation can be a click on an UI icon to initiate the target operation for managing the online digital asset. The target operation can be an operation mentioned in FIG. 2 and FIG. 3, such as Bid operation, Upload operation, or a Buy shares operation, etc.

Next, in step S450, the processor 110 sends a first request corresponding to the target operation to the server 200.

Next, in step S460, the processor 110 receives a first response corresponding to the first request from the server 200, wherein the first response is generated by a second processor of the server 200 corresponding to the target operation, so as to complete the managing of the digital asset.

For example, a target digital asset is uploaded by a Creator using her electronic device 100 executing a creation smart contract. The target digital asset can be stored in the electronic device 100 or server 200 and in this case, a reference link is stored as a block added to the ledger of the marketplace Blockchain; or the target digital asset itself is stored as a block added to the ledger of the marketplace Blockchain. Along with the target digital asset unload are identification information for the target digital asset, verification information related to the owner of the target digital asset, auxiliary information for the target digital asset, usage and licensing fee information, which are also stored as blocks added to the ledger. When the Creator wants to sell her shares in the target digital asset in the marketplace, the Marketplace module is initiated (i.e., the Marketplace UI is displayed) by the first input operation, then the Sell shares sub-UI is launched by second input operation, so as to send the server 200 a first request indicating that the shares of the target digital asset are on sale. The first request may include identification information for the target digital asset, verification information related to the owner of the target digital asset, initial share price, number of sales on sale, and/or other related information for bidding. Then, the server 200 initiates a share sale smart contract corresponding to this target digital asset share sale by the first request. A first response is generated by the share sale smart contract and sent back to the server 200, wherein the first response indicates that the status of the target digital asset is recorded as “on sale” as a block added to the ledger of the marketplace Blockchain. The share sale smart contract stands ready to manage/verify share sale transactions of the target digital asset. The server 200 sends the first response back to the electronic device 100.

In the description below, when one or more UI icons illustrated in the figures are clicked, the processor 110 executes the corresponding programs to: perform the corresponding operations, instruct the I/O circuit 140 to cause to display a corresponding UI/sub-UI, and/or send a corresponding generated request to the server 200 and/or one or more smart contracts. One or more UI function regions are used for grouping different displayed UI functional icons/images logically; but the invention is not limited hereto.

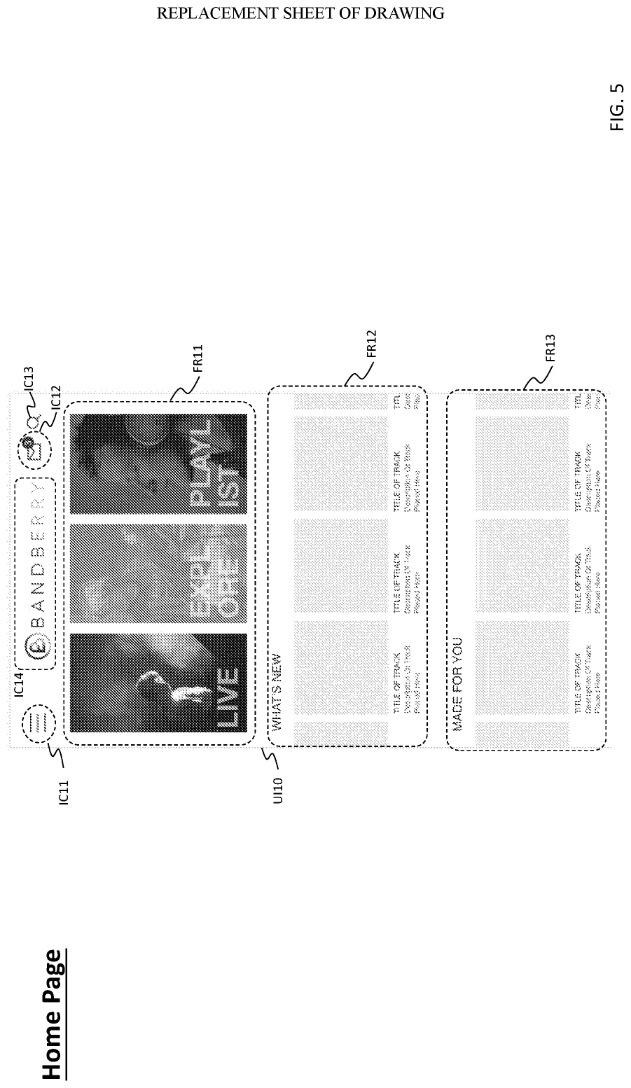

Referring to FIG. 5, for example, a Home Page UI (e.g., UI10 illustrated in the FIG. 5) includes UI function regions FR11 to FR13, and UI icons IC 11 to IC 14. UI function region FR11 includes several images (e.g., “LIVE”, “EXPLORE” and “PLAYLIST”), etc. When one of the images is clicked, a corresponding target module is initiated. In the UI function region FR12, several image links are displayed by the processor 110, wherein each image link shows related information of a new uploaded digital asset. In the UI function region FR13, several image links are displayed by the processor 110, wherein each image link shows related information of a recommended digital asset.

Furthermore, when UI icon IC11 is clicked, the processor 110 instructs the I/O circuit 140 to cause to display a function/operation list, and the function/operation list may include a plurality of UI function icons for respectively launching the foregoing primary UIs. The UI icon IC12 is an UI message icon used for launching a Messaging UI, wherein a number shown on the UI icon IC12 indicates the number of unread messages. The UI icon IC13 is used for launching the Search engine UI. The UI icon IC14 indicates the name of the software/application integrating the provided method and programs.

The Home Page UI is a default UI, and it serves as a starting point for a participant of any of the logical roles using her computing device (e.g., electronic device 100) in accessing the services of the online digital asset marketplace (e.g., interacting with the smart contracts related to the online digital asset marketplace).

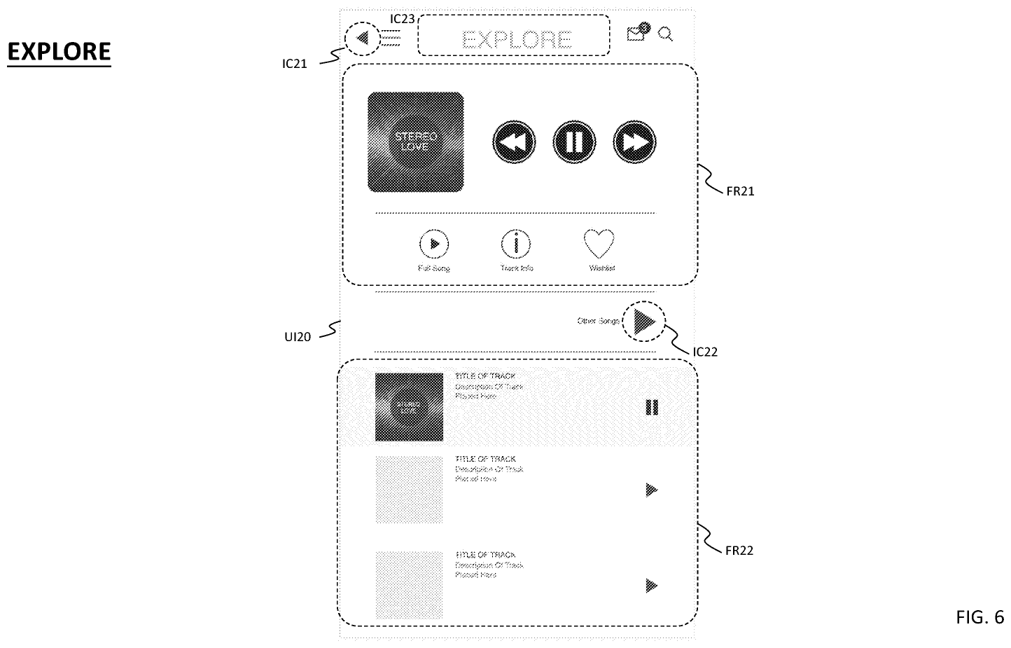

Referring to FIG. 6, the Explore UI (e.g., playing songs in this case) lists the digital assets owned or licensed by a participant of any of the logical roles using her computing device connected to the online digital asset marketplace.

For example, the Explore UI (UI20) includes UI function regions FR21 and FR22. The UI function region FR21 is a media player UI. The UI function region FR22 includes several cover images of songs, and “play” UI icons. When one of the images or “play” UI icons is clicked, a corresponding song is played by the media player displayed in the UI function region.

Furthermore, when UI icon IC21 is clicked, the processor 110 instructs the I/O circuit 140 to cause to display the Home Page UI. In other words, the UI icon IC21 is “Back” UI icon used for calling the Home Page UI. When UI icon IC22 is clicked, the processor 110 instructs the I/O circuit 140 to show other song candidates for playing. The UI icon IC23 indicates the name of the Explore UI, such that the user may see which UI is displayed currently.

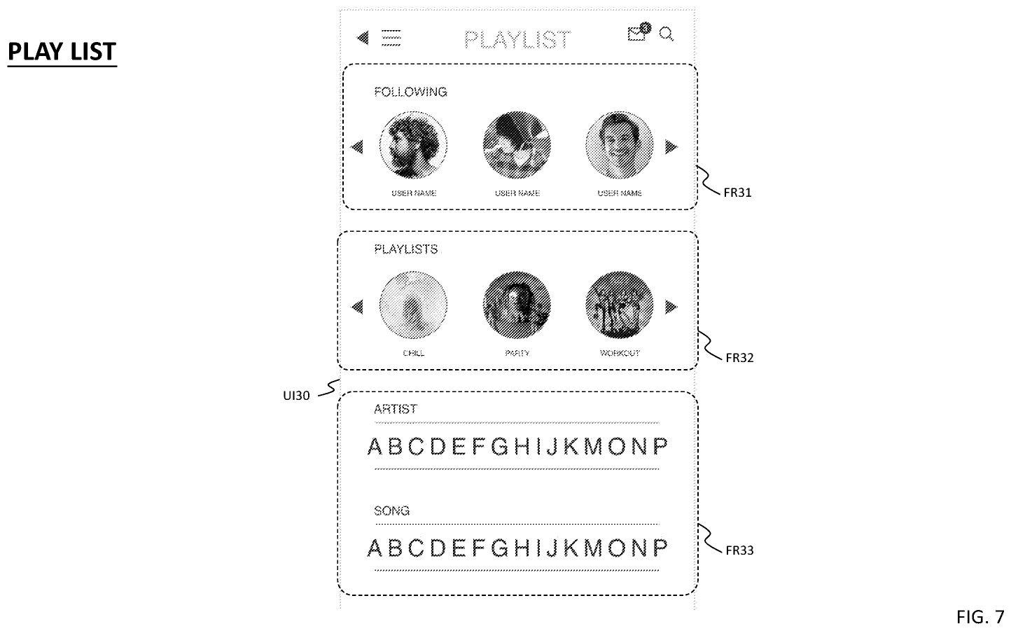

Referring to FIG. 7, the Playlist UI (e.g., UI30 illustrated in FIG. 7) shows the Curators' arrangements and collections access screen, wherein the UI30 lists the digital asset arrangements and collections, and it displays which Curators are available for a user of the Consumer role to follow using her computing device connected to the online digital asset marketplace.

For example, the Playlist UI (UI30) includes UI function regions FR31 to FR33. The UI function region FR31 shows the images that represent different Curators, wherein when one of the images is clicked, the processor 110 sends a corresponding request for a response containing data related to one or more arrangements, collections or playlists belonging to a Curator corresponding to the clicked image. Then, the processor 110 instructs the I/O circuit 140 to cause to display the arrangements, collections, or playlists according to the received response.

The function region FR32 shows images that represent different playlists, wherein when one of the images is clicked, the processor 110 instructs the I/O circuit 140 to cause to display a target playlist corresponding to the clicked image by recorded data. The UI function region FR33 displays sequences of letters used for searching for artists and songs.

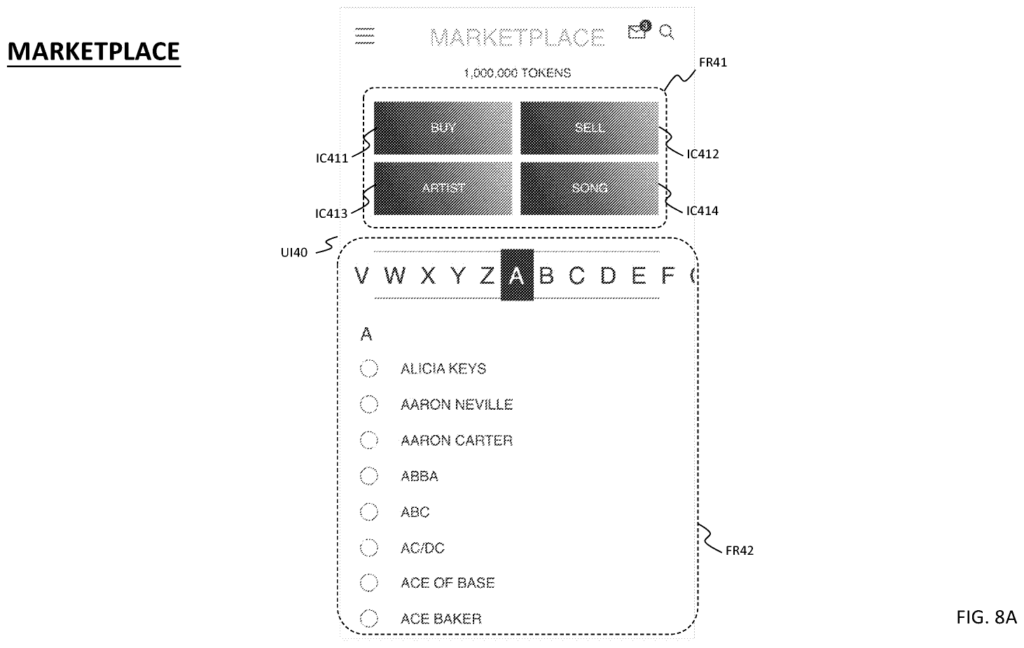

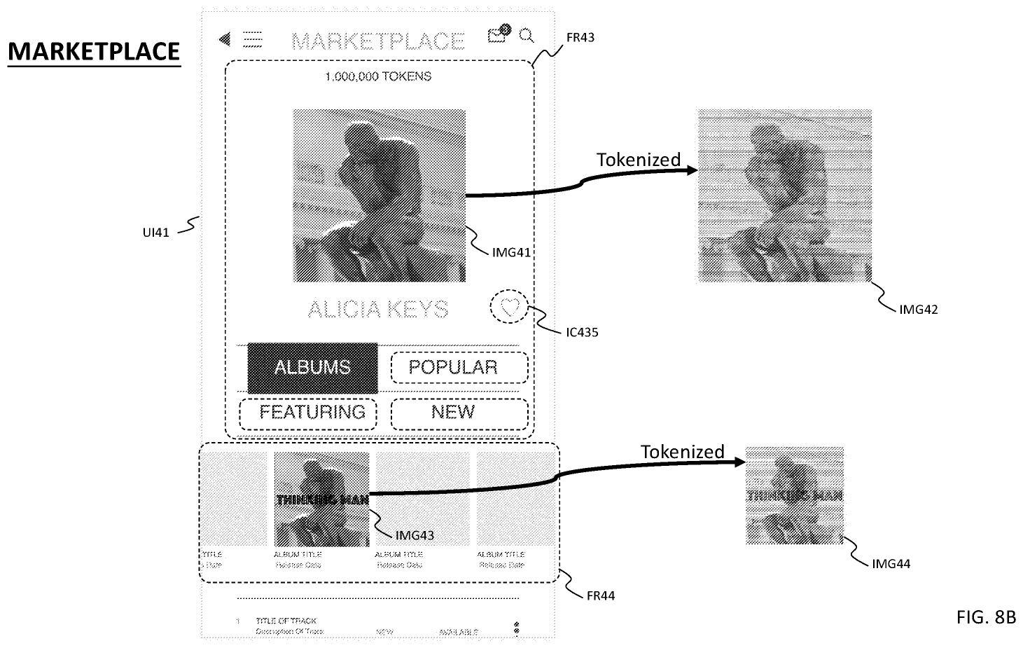

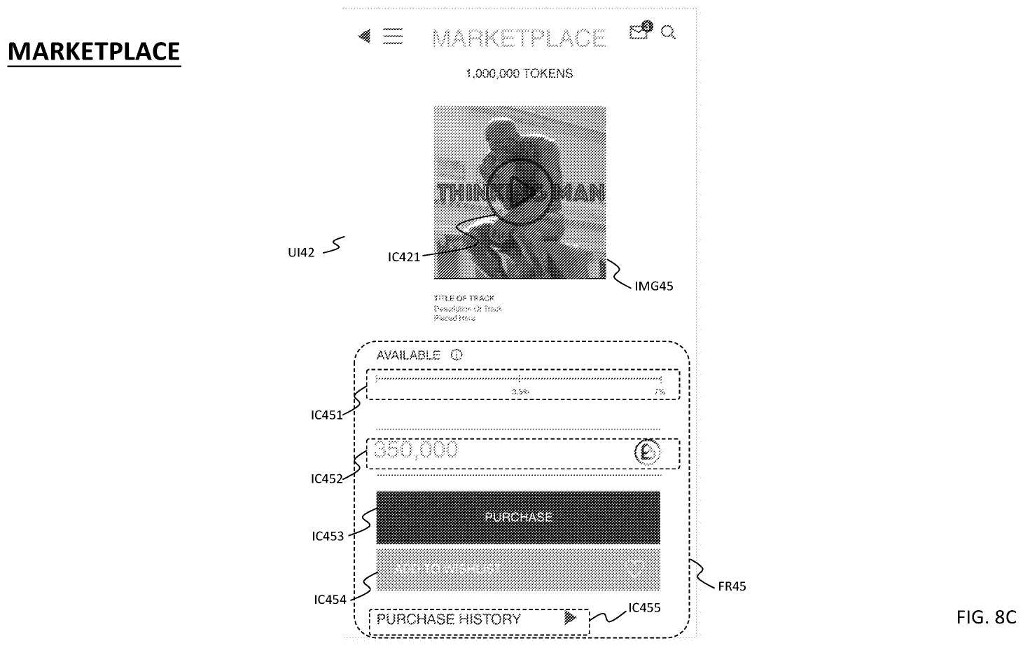

Referring to FIG. 8A, UI40 shows a digital asset (songs in this case) trading screen for a user to buy and sell digital assets using her computing device connected to the online digital asset marketplace.

The function region FR41 includes several UI icons IC411 to IC414, wherein when each of the UI icons IC411 to IC414 is clicked, the processor 110 instructs the I/O circuit 140 to cause to display the corresponding sub-UI to initiate the corresponding management function. For example, when the “ARTIST” UI icon IC413 is clicked, the processor 110 instructs the I/O circuit 140 to cause to display a sequence of letters for searching for a target artist who has one or more digital assets in the marketplace. When a specific target artist is selected, the processor 110 sends a corresponding request to a marketplace smart contract to obtain a corresponding response, so as to instruct the I/O circuit 140 to cause to display the Artist sub-UI of the selected target artist.

Referring to FIG. 8B, the Artist sub-UI (UI41) includes the UI function regions FR43 and FR44. The UI function region FR43 includes: a portrait IMG41 of the target artist, “ALBUMS” UI icon, “FEATURING” UI icon, “POPULAR” UI icon, and “NEW” UI icon. For example, when the “ALBUMS” UI icon IC431 is clicked, the processor 110 sends a corresponding request to the marketplace smart contract to obtain a response which contains data/information related to all albums of the target artist. Then the processor 110 shows one or more album cover images IMG43 in UI function region FR44.

In one embodiment, image IMG41 and image IMG43 can be “Tokenized”, “Binned”, “Converted” or “Divided” into a plurality of small image blocks. For example, as illustrated by FIG. 8B, the portrait IMG41 is tokenized into image IMG42, or the album cover image IMG43 is tokenized into image IMG44.

Referring to FIG. 8C, a digital asset (a song/track in this case) listing screen UI42 shows the digital asset for purchase/follow by a user using her computing device that is connected to the online digital asset marketplace.

For example, it is assuming that the album cover image IMG43 in FIG. 8B is clicked, the processor 110 executes the “Media Listing” program or machine instruction module and instructs the I/O circuit 140 to cause to display a Media Listing sub-UI (e.g., UI42 illustrated in FIG. 8C).

UI42 includes an image IMG45 and UI function region FR45, wherein the function region FR45 includes UI icons IC451 to IC455, wherein the image IMG45 includes an UI icon IC421. When UI icon IC421 is clicked, the processor 110 generate and send a corresponding response to the server 200 or the marketplace smart contract to obtain a response, wherein the response may include data of the entire song/album or a clip. Then the processor 110 can play the song/album according to the received response.

The UI icon IC451 (and the corresponding program or machine instruction module being executed) is used to set the percentage of shares to be purchased. The UI icon IC452 is used to set or show the number of shares to be purchased. The UI icon IC453 is used to complete the purchase of the set shares. The UI icon IC454 is used to add the song/album into a Wishlist. The UI icon IC455 is used to show the purchase history.

Referring to FIG. 8D, a digital asset (i.e., a song/track) Purchase screen UI43 shows the digital assets being purchased/followed by a user using her computing device that is connected to the online digital asset marketplace.

For example, assuming that the UI icon IC453 in FIG. 8C is clicked, the processor 110 executes the “Buy (or Purchase)” program module and instructs the I/O circuit 140 to display a Buy (or Purchase) sub-UI (e.g., UI43 illustrated in FIG. 8D).

UI43 includes an image IMG45 and UI function region FR46, wherein the UI function region FR46 includes icon IC461 to IC463. Furthermore, UI icon IC464 shows the remaining amount of deposit after the purchase.

The UI icon IC461 (and executed corresponding program module) is configured to show the percentage or number of shares to be purchased. The UIicon IC462 is configured to provide confirmation options for the user. The UI icon IC463 is configured to show the cover image if the collection/song/album been purchased.

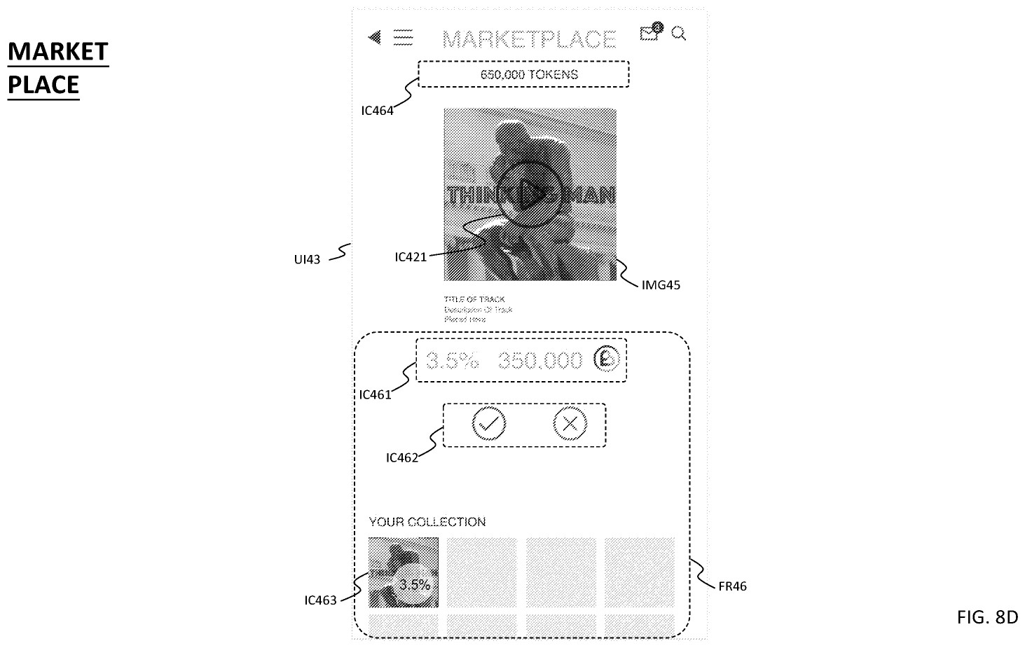

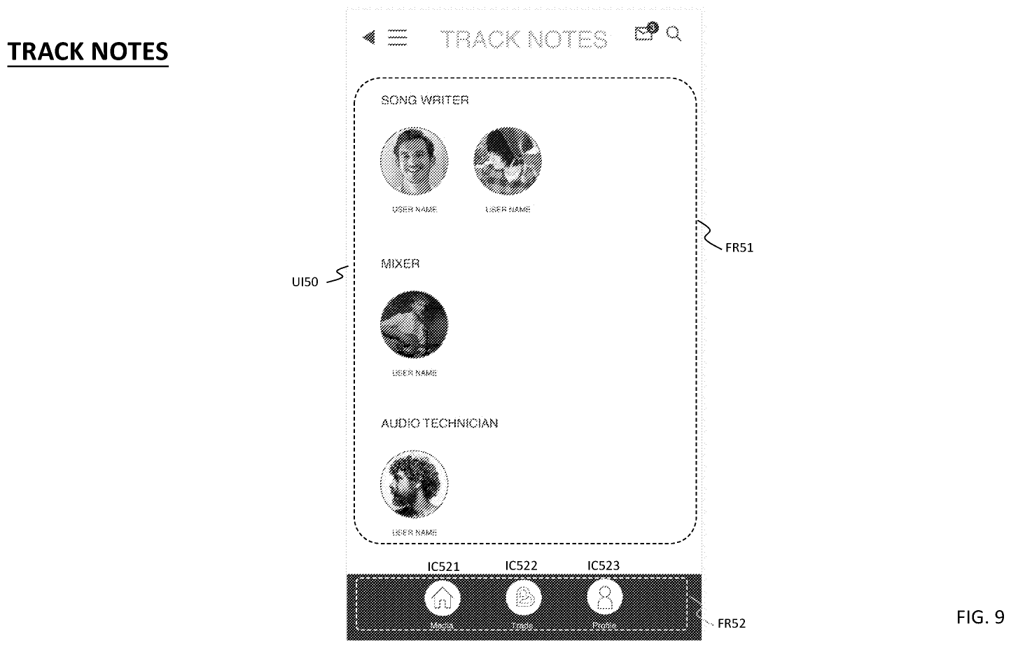

Referring to FIG. 9, a digital asset (a song/track in this case) details screen UI50 shows the digital asset's detailed information including Creators (i.e., song writer, mixer, audio technician, etc.) of the digital asset.

For example, UI50 includes UI function regions FR51 and FR52. The UI function region FR51 includes a plurality of images and information related to the Creators of this digital asset. The UI function region FR52 includes UI icons IC521 to IC523. The UI icon IC521 is configured to open the Home Page UI, the UI icon IC522 is configured to open the Marketplace UI (e.g., UI40), and the UI icon IC523 is configured to open the Profile UI.

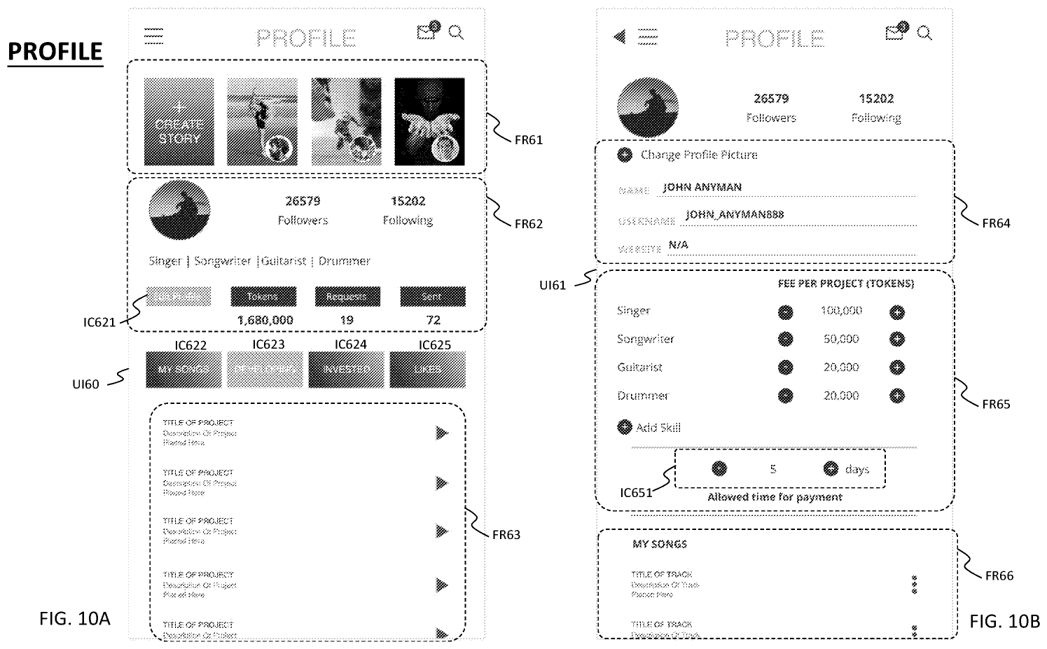

Referring to FIG. 10A, it shows a user profile screen UI60 for profile viewing and editing by a user of any of the logical roles using her computing device that is connected to the online digital asset marketplace.

UI60 includes UI function regions FR61 to FR63 and UI icons IC621 to IC625. The UI function region FR61 includes several cover images of created stories. The detail of each created story can be displayed by clicking the corresponding cover image. The UI function region FR62 shows basic information related to a Creator.

Furthermore, the UI icon IC621 is configured to open, upon being clicked on, a Profile editing sub-UI (as illustrated by FIG. 10B). The UI icon IC622 is configured to show, upon being clicked on, the digital assets (i.e., songs) in the inventory. The UI icon IC623 is configured to show, upon being clicked on, one or more developing projects that are being handled by the user. The UI icon IC624 is configured to show, upon being clicked on, the digital assets that are invested by the user. The UI icon IC625 is configured to show, upon being clicked on, the digital assets that have been “liked” by the user or to show one or more play lists of the user.

For example, when UI icon IC623 is clicked on, the processor 110 generates and sends a corresponding request to the server 200 to obtain a corresponding response. Then the processor 110 instructs the I/O circuit 140 to cause to display the Project lists in UI function region FR63. In one embodiment, the response is generated or outputted by a project smart contract.

Referring to FIG. 10B, an exemplary UI (e.g., UI61) for viewing and editing user's profile is depicted. UI61 includes setting a user's fee schedule for various digital asset creation and collaboration services such as songwriting, performance, etc.

For example, UI61 includes UI function regions FR64 to FR66. The UI function region FR64 includes data fields for editing the user's name, username, and website. The function region FR65 includes an UI icon IC651 and data fields for editing fees for the user to handle different projects. The UI icon IC651 is configured to allow, upon being clicked on, the editing of payment terms.

The UI function region FR66 shows detailed information related to “MY SONGS”, “DEVELOPING”, “INVESTED” and “LIKES”.

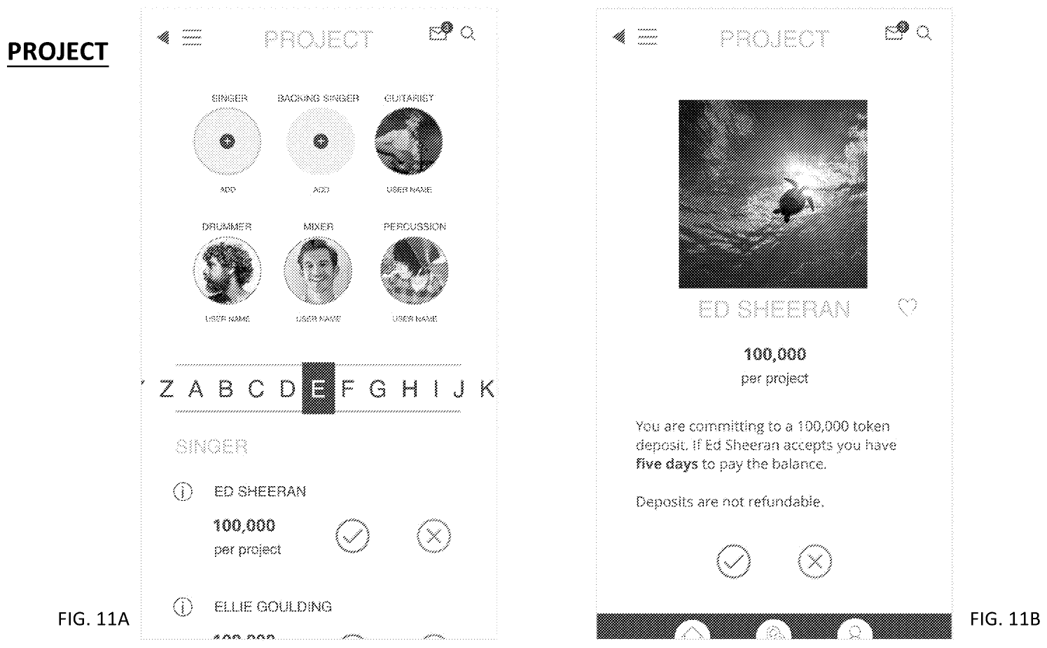

Referring to FIG. 11A, it shows an exemplary UI digital asset creation screen allowing one or more Creator or Collaborator to create or collaborate on a digital asset project, which is accessible by a participant in the Creator or Collaborator role using her computing device that is connected to the online digital asset marketplace.

Referring to FIG. 11B, it shows an exemplary UI digital asset investment screen to allow one or more Investor to invest (purchase shares) in a digital asset creation project.

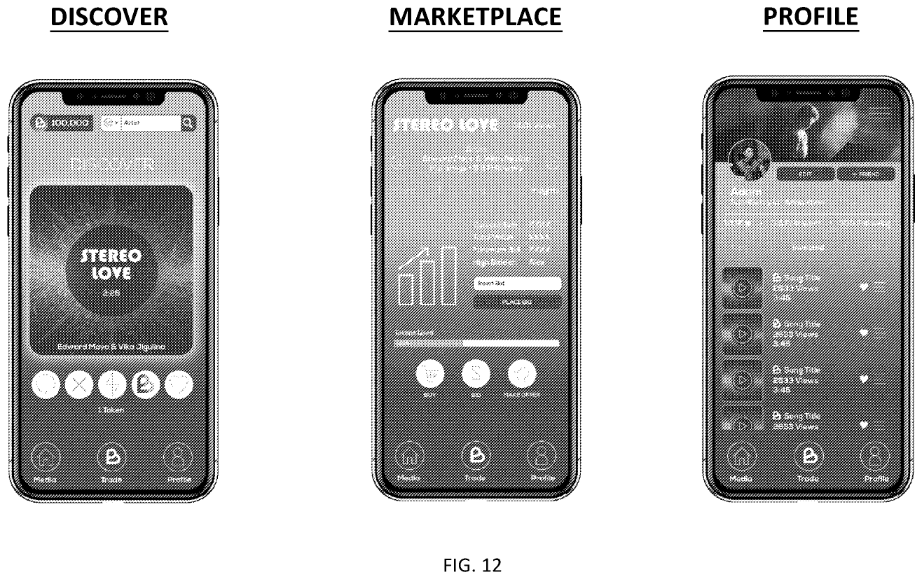

Referring to FIG. 12, in another embodiment, the primary UI further includes a Discover UI, a further Marketplace UI, and a further Profile UI.

The Creation module 1311 is configured to organize, generate and record information and metadata, including metadata on the smart contracts and NFTs, that represent one or more creators creating a digital asset and claiming originality and shares in its intellectual property rights.

For example, when the initiated target module (at step S420) is the Creation module, the processor 110 instructs the I/O circuit 140 to cause to display a Creation UI according to the target operation corresponding to the Creation module; wherein the target operation corresponding to the Creation module comprises: a NFT management operation, configured to generate one or more NFT of a target digital asset owned and uploaded by one or more Creators via a creation smart contract; or a registration operation, configured to register originality, shares and fees of the generated NFTs or the target digital asset, wherein the fees comprise a usage fee and an ownership fee.

The Collaboration module 1312 is configured to organize, generate and record information and metadata, including smart contracts, that facilitate and represent one or more Collaborators performing value-contributing activities, including, without limitation, distribution, promotion, certification, and valuation of the digital asset; and rewards distribution for the value-contributing activities.

For example, when the initiated target module (at step S420) is the Collaboration module, the processor 110 instructs the I/O circuit 140 to cause to display a Collaboration UI according to the target operation corresponding to the collaboration module; wherein the target operation corresponding to the Collaboration module comprises: a collaboration operation, configured to evaluating one or more contribution activities related to a target digital asset via a collaboration smart contract, wherein the contribution activities comprise: distribution, promotion, certification, and valuation of the target digital asset, wherein the collaboration smart contract further distributes rewards to one or more collaborators according to evaluated scores of the evaluated contribution activities performed by the Collaborators.

The Marketplace module 1313 is configured to organize, generate and record information and metadata, including smart contracts and blocks in the marketplace Blockchain, that represent and facilitate a digital asset's equity share issuances, share title assignments and records, and trading (or exchange) information of share ownerships such as shareholders' identifications, share prices, and shareholders' agreements which contain conditions, rights, and obligations, and distributions of share interests or dividends. The Marketplace module 1313 also facilitates the real-time reporting and recording of digital asset equity share prices, their trade executions among multiple buyers and sellers, and clearances. The creations, trade executions, reporting, and recording of other financial instruments derived from the equity shares and the underlying values of the digital assets can also be conducted automatically by the online digital asset marketplace.

For example, when the initiated target module (at step S420) is the Marketplace module, displaying a Marketplace UI of an online marketplace by the I/O circuit 140 according to the target operation corresponding to the Marketplace module, wherein the target operation corresponding to the Marketplace module is managed via a marketplace smart contract, and the target operation comprises: a selling operation, configured to sell shares of NFTs of an uploaded target digital asset; a buying operation, configured to buy shares of NFTs of a target digital asset on sale; an asset information management operation, configured to manage and display each of uploaded digital assets; a deposit/withdraw operation, configured to deposit/withdraw currency or cryptocurrency used in the online marketplace; or a bidding operation, configured to bid an auctioned digital asset.

As the underlying digital asset becomes more popular or desirable, and is being licensed, its royalty income increases; and, in turn, its share dividends. This in turn may drive up the demands on its shares, and it turn its share price; and vice versa.

The Consumer module 1314 is configured to organize, generate and record information and metadata, including smart contracts and blocks in the marketplace Blockchain, that represent and facilitate a digital asset's copyright licensing, which include the issuance of licenses with customizable terms (i.e., rights to use such as online streaming, rights to duplicate, rights to sub-license, etc.), enforcements of the licenses, and royalty payments of the licenses.

For example, when the initiated target module is the Consumer module, the processor 110 instructs the I/O circuit 140 to cause to display a Consumer UI according to the target operation corresponding to the Consumer module, wherein the target operation corresponding to the Consumer module comprises a license management operation, configured to manage the copyright licensing of a target digital asset. The license management comprises: issuance of licenses with customizable terms; and enforcements of the licenses; and royalty payments on the licenses.

The Curation module 1315 is configured to organize, generate and record information and metadata that represent 3rd party curators' (including e.g., knowledge opinion leaders, DJs, etc.) arrangements and collections (i.e., playlists) of a plurality of digital assets, and listings of these arrangements and collections (i.e., playlists) for Consumers to follow; and facilitate sales of inclusive spots in these arrangements and collections to digital asset creators and collaborators to purchase for including their digital assets in the arrangements and collections.

For example, when the initiated target module is the Curation module, the processor 110 instructs the I/O circuit 140 to cause to display a Curation UI according to the target operation corresponding to the Curation module, wherein the target operation corresponding to the Curation module comprises: a Curator information management, configured to manage information of one or more Curators, wherein the information of each Curator includes a Curator's profile, arrangements and collections; a playlist operation, configured to record one or more target Curators to follow, and links for accessing one or more target digital assets; a curation trading operation, configured to buy or sell a right to exhibit a digital asset in a Curator's arrangements, collections or playlists.

For example, when the initiated target module is the Verifier module, the processor 110 instructs the I/O circuit 140 to cause to display a Verifier UI according to the target operation corresponding to the Verifier module, wherein the target operation corresponding to the Verifier module comprises: a Verifier information management, configured to manage information of one or more Verifiers, wherein the information of each Verifier includes a Verifier's profile, a list of verified/endorsed Creators, and a list of verified/endorsed digital asset; a verification/endorsement operation, configured to allow a target Creator or a target digital asset to be verified/endorsed; and links for accessing one or more target Creators and target digital assets.

If a Creator is verified/endorsed, the display of such a Creator in all UI's (i.e., Marketplace UI) is marked by a verification/endorsement sign with the name of the Verifier who verified/endorsed the Creator. Similarly, if a digital asset is verified/endorsed, the display of such a digital asset in all UI's (i.e., Marketplace UI) is marked by a verification/endorsement sign with the name of the Verifier who verified/endorsed the digital asset.

The Verifier role may be granted to a user of the online digital asset marketplace by its system configuration based on the user's fame, celebrity status, or KOL status; or by nomination by the user community of the online digital asset marketplace.

In accordance with various embodiments of the present invention, the provided method, electronic device and the system are capable of facilitating data (including financial) transactions, structured interactions among a plurality of users, and accessing of services of the corresponding smart contracts and the online digital asset marketplace via the data communications among computing devices including, but not limited to, processing server computers, database server computers, personal computers, smartphones, electronic kiosks, and other mobile computing devices with special configurations for executing the various method processes. The online digital asset marketplace recognizes users in the logical roles of Creator, Collaborator, Consumer, Curator, Investor, and Verifier.

The above exemplary embodiment and operations serve only as illustration of the present invention, and an ordinarily skilled person in the art will appreciate that other structural and functional configurations and applications are possible and readily adoptable without undue experimentation and deviation from the spirit of the present invention.

The functional units of the apparatuses and the methods in accordance to embodiments disclosed herein may be implemented using computing devices, computer processors, or electronic circuitries including but not limited to application specific integrated circuits (ASIC), field programmable gate arrays (FPGA), and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments include computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units in accordance to various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

What is claimed is:

1. A computer-implemented method for managing a digital asset by an electronic device of a system, comprising:
receiving, by a first processor of the electronic device, a first input data generated in response to an applied first input operation, wherein the first input operation is applied on an I/O circuit if the electronic device;
enabling, by the first processor, a target module among a plurality of modules according to the first input data,
wherein the modules comprise a home page module, a creation module, a collaboration module, a marketplace module, a consumer module, a curation module, and a verifier module;
receiving, by the first processor, a second input data generated in response to an applied second input operation;
performing, by the first processor, a target operation of the target module for managing the online digital asset according to the second input data;
sending, by the first processor, a first request corresponding to the target operation to a server;
receiving, by the first processor, a first response corresponding to the first request from a server, wherein the first response is generated by a second processor of the server via a smart contract corresponding to the target operation, so as to complete the managing of the online digital asset.

2. The computer-implemented method of claim 1, when the initiated target module is the creation module, displaying a creation user interface (UI) by the I/O circuit according to the target operation corresponding to the creation module,
wherein the target operation corresponding to the creation module comprises:
a non-fungible tokens (NFTs) management operation, configured to generate one or more NFTs of a target digital asset owned and uploaded by one or more creators via a creation smart contract; or
a registration operation, configured to register originality, shares and fees of the generated NFTs or the target digital asset, wherein the fees comprise a usage fee and an ownership fee.

3. The computer-implemented method of claim 1, when the initiated target module is the collaboration module,
displaying a collaboration UI by the I/O circuit according to the target operation corresponding to the collaboration module,
wherein the target operation corresponding to the collaboration module comprises:
a collaboration operation, configured to evaluate one or more contribution activities related to a target digital asset via a collaboration smart contract, wherein the contribution activities comprise: distribution, promotion, certification, and valuation of the target digital asset,
wherein the collaboration smart contract further distributes rewards to one or more collaborators according to evaluated scores of the evaluated contribution activities performed by the collaborators.

4. The computer-implemented method of claim 1, when the initiated target module is the marketplace module,
displaying a marketplace UI of an online marketplace by the I/O circuit according to the target operation corresponding to the marketplace module,
wherein the target operation corresponding to the marketplace module is managed via a marketplace smart contract, and the target operation comprises:
a selling operation, configured to sell shares of NFTs of an uploaded target digital asset;
a buying operation, configured to buy shares of NFTs of a target digital asset on sale;
an asset information management operation, configured to manage and display each of uploaded digital assets;
a deposit/withdraw operation, configured to deposit/withdraw currency or cryptocurrency used in the online marketplace; or
a bidding operation, configured to bid an auctioned digital asset.

5. The computer-implemented method of claim 1, when the initiated target module is the consumer module,
displaying a consumer UI by the I/O circuit according to the target operation corresponding to the consumer module,
wherein the target operation corresponding to the consumer module comprises:
a license management operation, configured to manage a consumer licensing of copyright of a target digital asset, comprising managing:
issuance of licenses with customizable terms; and
enforcements of the licenses; and payments of the licenses.

6. The computer-implemented method of claim 1, when the initiated target module is the curation module,
displaying a curation UI by the I/O circuit according to the target operation corresponding to the curation module,
wherein the target operation corresponding to the curation module comprises:
a curator information management, configured to manage information of one or more curators, wherein the information of each curator includes a curator's profile, arrangements, collections and playlists for one or more consumers to follow;
a playlist operation, configured to record one or more target curators to follow, and links for accessing one or more target digital assets; and
a curation trading operation, configured to buy or sell a right to exhibit a digital asset in a curator's arrangements, collections or playlists.

7. An electronic device for managing an online digital asset, comprising:
a first processor, configured to execute machine instructions to implement a method to manage the online digital asset, and the method comprises:
receiving, by a first processor of the electronic device, a first input data generated in response to an applied first input operation, wherein the first input operation is applied on an I/O circuit if the electronic device;
enabling, by the first processor, a target module among a plurality of modules according to the first input data,
wherein the modules comprise a home page module, a creation module, a collaboration module, a marketplace module, a consumer module, a curation module, and a verifier module;
receiving, by the first processor, a second input data generated in response to an applied second input operation;
performing, by the first processor, a target operation of the target module for managing the online digital asset according to the second input data;
sending, by the first processor, a first request corresponding to the target operation to a server;
receiving, by the first processor, a first response corresponding to the first request from a server, wherein the first response is generated by a second processor of the server via a smart contract corresponding to the target operation, so as to complete the managing of the online digital asset.

8. The electronic device of claim 7, when the initiated target module is the creation module,
displaying a creation user interface (UI) by the I/O circuit according to the target operation corresponding to the creation module,
wherein the target operation corresponding to the creation module comprises:
a non-fungible tokens (NFTs) management operation, configured to generate one or more NFTs of a target digital asset owned and uploaded by one or more creators via a creation smart contract; or
a registration operation, configured to register originality, shares and fees of the generated NFTs or the target digital asset, wherein the fees comprise a usage fee and an ownership fee.

9. The electronic device of claim 7, when the initiated target module is the collaboration module,
displaying a collaboration UI by the I/O circuit according to the target operation corresponding to the collaboration module,
wherein the target operation corresponding to the collaboration module comprises:
a collaboration operation, configured to evaluate one or more contribution activities related to a target digital asset via a collaboration smart contract, wherein the contribution activities comprise: distribution, promotion, certification, and valuation of the target digital asset,
wherein the collaboration smart contract further distributes rewards to one or more collaborators according to evaluated scores of the evaluated contribution activities performed by the collaborators.

10. The electronic device of claim 7, when the initiated target module is the marketplace module,
displaying a marketplace UI of an online marketplace by the I/O circuit according to the target operation corresponding to the marketplace module,
wherein the target operation corresponding to the marketplace module is managed via a marketplace smart contract, and the target operation comprises:
a selling operation, configured to sell shares of NFTs of an uploaded target digital asset;
a buying operation, configured to buy shares of NFTs of a target digital asset on sale;
an asset information management operation, configured to manage and display each of uploaded digital assets;
a deposit/withdraw operation, configured to deposit/withdraw currency or cryptocurrency used in the online marketplace; or
a bidding operation, configured to bid an auctioned digital asset.

11. The electronic device of claim 7, when the initiated target module is the consumer module,
displaying a consumer UI by the I/O circuit according to the target operation corresponding to the consumer module,
wherein the target operation corresponding to the consumer module comprises:
a license management operation, configured to manage a consumer licensing of copyright of a target digital asset, comprising managing:
issuance of licenses with customizable terms; and
enforcements of the licenses; and payments of the licenses.

12. The electronic device of claim 7, when the initiated target module is the curation module,
displaying a curation UI by the I/O circuit according to the target operation corresponding to the curation module,
wherein the target operation corresponding to the curation module comprises:
a curator information management, configured to manage information of one or more curators, wherein the information of each curator includes a curator's profile, arrangements, collections and playlists;
a playlist operation, configured to record one or more target curators to follow, and links for accessing one or more target digital assets; and
a curation trading operation, configured to buy or sell a right to exhibit a digital asset in a curator's arrangements, collections or playlists.

13. A system for managing an online digital asset, comprising:
an electronic device comprising a first processor; and
a server comprising a second processor,
wherein the first processor is configured to execute machine instructions to implement a method to manage an online digital asset, and the method comprises:
receiving, by a first processor of the electronic device, a first input data generated in response to an applied first input operation, wherein the first input operation is applied on an I/O circuit if the electronic device;
enabling, by the first processor, a target module among a plurality of modules according to the first input data,
wherein the modules comprise a home page module, a creation module, a collaboration module, a marketplace module, a consumer module and a curation module;
receiving, by the first processor, a second input data generated in response to an applied second input operation;
performing, by the first processor, a target operation of the target module for managing the online digital asset according to the second input data;
sending, by the first processor, a first request corresponding to the target operation to a server; and
receiving, by the first processor, a first response corresponding to the first request from a server, wherein the first response is generated by a second processor of the server via a smart contract corresponding to the target operation, so as to complete the managing of the online digital asset.

14. The computer-implemented method of claim 1, when the initiated target module is the verifier module,
displaying a verifier UI by the I/O circuit according to the target operation corresponding to the verifier module,
wherein the verifier operations corresponding to the verifier module comprise:
a verifier information management, configured to manage information of one or more verifiers, wherein the information of each verifier includes a verifier's profile, a list of verified/endorsed creators, and a list of verified/endorsed digital assets;
a verification/endorsement operation, configured to allow a target creator or a target digital asset to be verified/endorsed, and links to be created for accessing one or more target creators and target digital assets;
wherein if a creator is verified/endorsed, display of such a creator in all UI's is marked by a verification/endorsement sign with name of the corresponding verifier who verified/endorsed the creator; and
wherein, if a digital asset is verified/endorsed, display of such a digital asset in all UI's is marked by a verification/endorsement sign with name of the corresponding verifier who verified/endorsed the digital asset.

15. The electronic device of claim 7, when the initiated target module is the verifier module,
displaying a verifier UI by the I/O circuit according to the target operation corresponding to the verifier module,
wherein the verifier operations corresponding to the verifier module comprise:
a verifier information management, configured to manage information of one or more verifiers, wherein the information of each verifier includes a verifier's profile, a list of verified/endorsed creators, and a list of verified/endorsed digital assets;
a verification/endorsement operation, configured to allow a target creator or a target digital asset to be verified/endorsed, and links to be created for accessing one or more target creators and target digital assets;
wherein if a creator is verified/endorsed, display of such a creator in all UI's is marked by a verification/endorsement sign with name of the corresponding verifier who verified/endorsed the creator; and
wherein, if a digital asset is verified/endorsed, display of such a digital asset in all UI's is marked by a verification/endorsement sign with name of the corresponding verifier who verified/endorsed the digital asset.
